(19) United States
(12) Patent Application Publication
(10) Pub. No.: US 2012/0141821 A1
(43) Pub. Date: Jun. 7, 2012

(54) BATHROOM APPLIANCE

(76) Inventors: Axel ROST, Lahr (DE); Rene Musielik, Schwanau (DE); Ingrid Ueckert, Mahlberg (DE)

(21) Appl. No.: 13/305,137

(22) Filed: Nov. 28, 2011

(30) Foreign Application Priority Data
Dec. 3, 2010 (EP) EP10015282.6

(51) Int. Cl. B21D 39/00; C25D 5/56; C25D 5/12; B32B 15/00

(52) U.S. Cl. 428/621; 428/661; 205/164; 205/178

(57) ABSTRACT

A bathroom appliance is provided having a substrate made of metal or plastic and a coating, it is provided to consecutively electroplate metal layers made of copper, an alloy of copper and tin, and chromium and to subsequently apply a cover layer which is made of at least one of the elements of chromium, titanium, zirconium, gold, silver or platinum or is made of a chemical combination of the elements of titanium or chromium and nitrogen and, optionally, carbon, the cover layer being produced on the electroplated chromium layer by means of a PVD method.

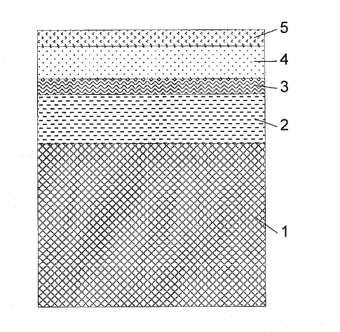

This nonprovisional application claims priority under 35 U.S.C.§119(a) to European Patent Application No. EP10015282.6, which was filed on Dec. 3, 2010, and which is herein incorporated by reference.

### BACKGROUND OF THE INVENTION

1. Field of the Invention

The invention relates to a bathroom appliance as well as to a method for the manufacture thereof.

2. Description of the Background Art

The invention relates to bathroom fixtures and installation products, shower heads, faucets or escutcheons and sink tops which must be resistant to corrosion, friction and aggressive chemicals, on the one hand, and have a decorative surface including a predetermined coloring, on the other hand. Numerous methods for applying decorative layers are known from the prior art. In addition to wet chemical methods such as electroplating processes, methods such as PVD (physical vapor deposition), CVD (chemical vapor deposition) and lacquering methods as well as combinations thereof are known by means of which layers having certain colors may be deposited on the objects.

Electroplated coatings are primarily used for bathroom appliances made of brass or plastic, if only for cost reasons. A layer made of an electrolyte containing nickel is usually deposited as well as a layer made of an electrolyte containing chromium VI for the top layer.

Due to health aspects and increasingly stricter regulations relating to the quality of drinking water, however, these conventional layers have come under criticism.

Even if no trace of chromium VI is detectable in the final layer after chromium-plating, the use in the bathrooms is hazardous since chromium VI compounds are known to be extremely toxic, carcinogenic and genetically harmful.

Moreover, nickel is known to be a trigger for contact allergies. Even if the nickel layer is not a cover layer in bathroom fixtures, contact with the drinking water may under certain circumstance result in the release of nickel, since the chromium layer does not have to be applied with full coverage in all locations.

In addition, the base material for the bathroom fixtures contains brass, usually an admixture of lead, in order to improve the machinability of the fixture bodies when machining them after casting. Lead and lead compounds which are extracted from the brass also have a toxic effect on people. Moreover, they are hazardous, since, if ingested steadily over long periods of time, they may become deposited in the bones in the body and result in chronic intoxication.

### SUMMARY OF THE INVENTION

It is therefore an object of the invention to manufacture bathroom appliances in which harmful emissions are reduced as far as possible. Emissions are understood to be the release of toxic chemical substances which are harmful to the health or to the environment, such as harmful substances of all types, irritants, allergens, etc.

According to an embodiment of the invention, a bathroom appliance having a base body made from a substrate is provided which is provided with a decorative coating, the substrate made of plastic or metal, in particular brass, aluminum, zinc or high-grade steel, and the coating including a layer sequence of metal layers which are produced by means of electroplating methods and PVD methods. Coating is understood to be the application of a firmly adhering layer made of an amorphous material onto a workpiece. The coating and substrate form a composite member made of different materials. The coating performs the contact function, such as protecting against chemical or corrosive attacks and against tribological stress, influences the friction behavior or is used for optical or decorative purposes, while the substrate performs the supporting function, it being possible to adapt the properties thereof to the specific stress without having to take the contact behavior into account.

According to another embodiment of the invention, a bathroom appliance is thus provided from a substrate made of metal or plastic and an electroplated coating which includes consecutive metal layers. Copper is provided as the first layer, an alloy of copper and tin as the second layer and chromium as the third layer. The coating furthermore has a cover layer which is made of at least one of the elements of chromium, titanium, zirconium, gold, silver or platinum or is made of a chemical combination of the elements of titanium or chromium and nitrogen and, optionally, carbon, which is produced on the electroplated chromium layer by means of a PVD method.

For example, a chromium layer, a chromium nitride layer, a titanium carbon nitride layer or a high-grade steel layer may be provided as the cover layer.

According to an advantageous embodiment of the invention, the second metal layer, which is made of an alloy of copper and tin, has a defined mixing ratio. An alloying ratio of 40% to 60% of copper and 60% to 40% of tin is preferably provided.

The electroplated chromium layer is preferably deposited from an electrolyte containing chromium III so that the use of chromium VI may be avoided.

An embodiment of the invention provides that the substrate of the bathroom appliance is made of brass. A lead-free alloy or a lead-reduced alloy which includes the main alloy constituents of copper and zinc is preferably used. In connection with the substrate coating according to the invention, it is thus possible to manufacture a bathroom appliance in which the influence of substances which are harmful to the health may be nearly eliminated during both the manufacture and use thereof.

The method for manufacturing the bathroom appliances according to the invention from substrates such as metal or plastic and their decorative metallic surfaces has the following method steps. First, the bathroom appliance is produced from the substrate by means of a casting method or an injection molding method. The molded substrate is then machined, cleaned and prepared for coating. The electroplated metal layers are first applied to the substrate. To lend color to the bathroom appliance, the first metal layer is followed by a metal layer made of an alloy of copper and tin, so-called white bronze. The white bronze layer replaces the otherwise customary nickel layer which is otherwise used to achieve the desired “chrome color.” An electroplated chromium layer is subsequently applied to the substrate. This concludes the electroplated coating. The cover layer is followed by a layer made of at least one of the elements of chromium, titanium, zirconium, gold, silver or platinum or a layer made of a chemical combination of the elements of titanium or chromium and nitrogen and, optionally, carbon, which is applied with the aid of the PVD method. The final cover layer is therefore also referred to as the hard material layer.

Further scope of applicability of the present invention will become apparent from the detailed description given hereinafter. However, it should be understood that the detailed description and specific examples, while indicating embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the figure shows a section of a layer structure of a bathroom appliance according to an embodiment of the invention.

### DETAILED DESCRIPTION

In a bathroom appliance, the substrate made of lead-free brass 1 is provided, for example, as a casting. To produce a high-shine, corrosion-resistant surface, the casting is first electroplated. For this purpose, copper 2, an alloy 3 of copper and tin are first consecutively deposited, followed by the deposition of a chromium layer 4, taking into account the necessary intermediate steps and rinsing operations. In contrast, final cover layer 5, or hard layer, made for example from titanium nitride, is deposited in a vacuum chamber by means of a PVD method.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A bathroom appliance having a substrate and a coating, the bathroom appliance comprising:
a substrate made of metal or plastic;
an electroplated coating having consecutive metal layers made of copper;
an alloy of copper and tin;
chromium; and
a cover layer made of at least one of the elements of chromium, titanium, zirconium, gold, silver or platinum or of a chemical combination of the elements of titanium or chromium and nitrogen and, optionally, carbon, which is produced on the electroplated chromium layer via a PVD method.

2. The bathroom appliance according to claim 1, wherein the second layer, which is made of an alloy of copper and tin, is provided in a defined mixing ratio of 60% copper and 40% tin.

3. The bathroom appliance according to claim 1, wherein the electroplated chromium layer is deposited from a chromium III electrolyte.

4. The bathroom appliance according to claim 1, wherein the substrate is made of brass, zinc, high-grade steel or aluminum.

5. The bathroom appliance according to claim 4, wherein a lead-free or lead-reduced alloy, which has the main alloy constituents of copper and zinc, is provided.

6. A method for producing bathroom appliances having substrates made of metal or plastic and having decorating metallic surfaces, the method comprising:
coating a substrate with a first metal layer made of copper;
coating the substrate with a second electroplated metal layer which is made of an alloy of copper and tin;
coating the substrate with an electroplated chromium layer; and
coating the substrate with a cover layer using the PVD method.

7. The method according to claim 6, wherein fixture bodies or water-conducting members, which are produced by casting, injection molding, stamping, pressing or deep drawing, are provided as substrates for the bathroom appliances.
